(19) United States
(12) Patent Application Publication
(10) Pub. No.: US 2025/0388441 A1
(43) Pub. Date: Dec. 25, 2025

(54) System For Lifting And Moving A Target Lift Object

(71) Applicant: Google LLC, Mountain View, CA (US)

(72) Inventors: Avinash Panga, Woodinville, WA (US); William John Nary, Seattle, WA (US); Toby Xu, Kirkland, WA (US)

(21) Appl. No.: 18/769,918

(22) Filed: Jul. 11, 2024

Related U.S. Application Data
(60) Provisional application No. 63/663,395, filed on Jun. 24, 2024.

(51) Int. Cl. B66F 9/12; B66F 9/06; B66F 9/075

(52) U.S. Cl. CPC B66F 9/075; B66F 9/063; B66F 9/07572; B66F 9/12

(57) ABSTRACT

The present invention relates to a lifting and transporting device. The device of the invention is useful for lifting and moving any object which has a pair of spaced apart wheels but is particularly adapted for the lifting and transporting of hospital beds. The bed lifter includes an improved means of supporting the load of a bed and/or bed/patient combination during lifting and transportation.

### CROSS-REFERENCE TO RELATED APPLICATION

This application claims the benefit under 35 U.S.C. § 119(e) of the filing date of U.S. Provisional Patent Application No. 63/663,395, for System For Lifting And Moving A Target Lift Object, which was filed on Jun. 24, 2024, and which is incorporated here by reference.

### BACKGROUND

Machines, such as robots for automated server handling, are used in data centers for swapping, removing, or inserting server trays on server racks. These machines are difficult to move within data centers, especially because data centers have narrow aisles with tight corners. Machines may need to be moved for repair if immobilized in a location in which the machine cannot be repaired. Additionally, machines may need to be moved off a pallet upon initial delivery to a data center. The bottom surface of a machine may not have enough clearance for forklifts to be able to lift the machine. Even when a forklift can physically access the bottom surface of the machine, lifting the machine with the forklift can be unstable and prevent the machine from being moved around tight spaces, such as in between aisles of a data center.

### BRIEF SUMMARY

Aspects of the disclosure are directed to systems, devices, and methods for lifting and moving a target lift object. A lifting tool and caboose tool may each engage opposing and parallel sides of the target lift object. To engage the target lift object, the lifting tool may have a bracket with holes configured to receive shafts on one side of the target lift object, and the caboose tool may have lifting protrusions configured to be received within holes on the opposing side of the target lift object. The lifting protrusions on the caboose tool may be of the same or similar structure as the shafts on the target lift object, and the holes in the target lift object may be the same structure or similar structure as the holes in the bracket on the lifting tool. To lift the target lift object, the lifting and caboose tools may have lifting mechanisms that translate along a vertical axis. To move the target lift object, the lifting tool may be manually or autonomously manipulated for lifting and moving a target lift object, such as a data center robot.

One aspect of the disclosure is directed to a lifting tool, which may have a main body configured to be connected to at least one wheel and a bracket. The bracket may be translatable along a vertical axis on the main body and may include two sets of holes parallel to each other. Each hole may have a first width and a second width longer than and parallel to the first width. A distance from the first width and the at least one wheel may be shorter than a distance from the second width and the at least one wheel.

In some examples, the bracket may be rotatable about along the vertical axis.

In some examples, the at least one hole may be a main circle with a smaller circle intersecting the main circle. The first width may be within the smaller circle, and the second width may be within the main circle. In other examples, the at least one hole may be keyhole shaped. In other examples, the at least one hole may be ovoid.

In some examples, the two sets of holes may each include two holes in a vertical line.

In some examples, the lifting tool may be a mobile robot configured to push a target lift object.

In some examples, the lifting tool may include a motor.

In some examples, the lifting tool may include a lock pin adjacent to the at least one wheel and configured to prevent the at least one wheel from rotation.

Another aspect of the disclosure is directed to a system for lifting and moving a target lift object. The system may include a lifting tool, which may have a main body connected to at least one wheel and a bracket. The bracket may include two sets of holes parallel to each other. Each hole may have a first width and a second width longer than and parallel to the first width, and a distance from the first width and the at least one wheel may be smaller than a distance from the second width and the at least one wheel. The system may also include a target lift object, which may have a first side with at least one shaft with a cap on an end of the shaft farthest from the target lift object. The shaft may be configured to be received within the holes. The cap may be configured to prevent disengagement of the shaft once the shaft is engaged with a portion of the holes within the first width.

In some examples, the target lift object may include at least one sensor configured to detect input in a space between the two sets of holes.

In some examples, the system may also include a caboose tool configured to engage with a second side of the target lift object opposing and parallel to the first side of the target lift object. In some examples, the caboose tool may include a lifting protrusion configured to be received within a lifting hole on the second side of the target lift object. In some examples, the caboose tool may include a hand crank on a side of the caboose tool opposite of the lifting protrusions. The hand crank may be configured to engage a lifting mechanism to lift the target lift object.

In some examples, a lowest portion of the lifting tool may be in line with a lowest portion of the target lift object. In other examples, a lowest portion of the lifting tool may be below a lowest portion of the target lift object. In some examples, the lowest portion of the lifting tool is three inches below the lowest portion of the target lift object.

In some examples, the system may also include treads configured to receive the at least one wheel on the lifting tool and configured to move the lifting tool in at least one direction.

Another aspect of the disclosure is directed to a method of lifting and moving a target lift object. The method may include engaging, by a mobile robot, a shaft on a target lift object with a hole on a bracket connected to a lifting tool. The hole may have a first width and a second width longer than and parallel to the first width. The method might also include moving, by the mobile robot, the bracket along a vertical axis so that the shaft transitions from an initial engagement position within the second width of the hole to a locking position within the first width of the hole. A cap on the shaft may prevent disengagement of the shaft in the locking position.

In some examples. the lifting tool may be the mobile robot. The step of engaging the shaft with a hole may include guiding the lifting tool using a control device. The lifting tool can include one of more of the features described above.

### BRIEF DESCRIPTION OF THE DRAWINGS

FIG. 1A is a front view of an example lifting tool, according to aspects of the disclosure.

FIG. 1B is a perspective view of the example lifting tool of FIG. 1A.

FIG. 2A is a side view of an example target lift object with shafts, according to aspects of the disclosure.

FIG. 2B is a side view of the opposing side of the example target lift object of FIG. 2A.

FIG. 3A is a perspective view of an example caboose tool, according to aspects of the disclosure.

FIG. 3B is a perspective view of the opposing side of the example caboose tool of FIG. 3A.

FIG. 4 is a side view of an example system including the lifting tool of FIG. 1A, the caboose tool of FIG. 3A, and the target lift object of FIG. 2A in an initial engagement position, in which the target lift object is on the ground.

FIG. 5 is a side view of an example system including the lifting tool of FIG. 1A, the caboose tool of FIG. 3A, and the target lift object of FIG. 2A in an initial engagement position, in which the target lift object is on a surface above the ground.

FIG. 6 is a side view of the system of FIG. 5 in a locked position.

FIG. 7 is a block diagram of an example system for lifting and moving an example target lift object, according to aspects of the disclosure.

FIG. 8 is a flow diagram of an example process for lifting and moving a target lift object, according to aspects of the disclosure.

### DETAILED DESCRIPTION

Aspects of the disclosure are directed to a system for lifting and moving a target lift object. A lifting tool and caboose tool may each engage opposing and parallel sides of the target lift object. To engage the target lift object, the lifting tool may have a bracket with holes configured to receive shafts on one side of the target lift object, and the caboose tool may have lifting protrusions configured to be received within holes on the opposing side of the target lift object. The lifting protrusions on the caboose tool may be the same or similar structure as the shafts on the target lift object, and the holes in the target lift object may be the same or similar structure as the holes in the bracket on the lifting tool. This system that lifts and moves a target lift object from its side surfaces results in improved stability compared to lifting and moving a target lift object from its bottom surface, such as with a forklift. Additionally, this system allows a target lift object to be lifted from any opposing and parallel side surfaces, even side surfaces with a narrow width, allowing target lift objects to be moved in narrow spaces and along tight corners. For example, the system may be configured to navigate an aisle having a width of 48 inches or more. The width the system is configured to navigate in various examples can depend on the width of the target lift object, e.g., to allow for enough space to move the target lift object with limited clearance on either side in the aisle.

To lift the target lift object, the lifting and caboose tools may have lifting mechanisms that translate along a vertical axis. The lifting and caboose tools are configured so that the target lift object may be moved from a position on the ground or from an elevated position. This system can therefore be used to move a target lift object off a pallet or other platform. For example, the pallet height may be three inches, and the lifting and caboose tools can be configured to lift the target lift object from the ground or an elevated position up to three inches high.

To lift and move the target lift object, the lifting tool and the caboose tool may be manually or autonomously manipulated. The bracket on the lifting tool may be pivotable so that the system can be moved around tight corners.

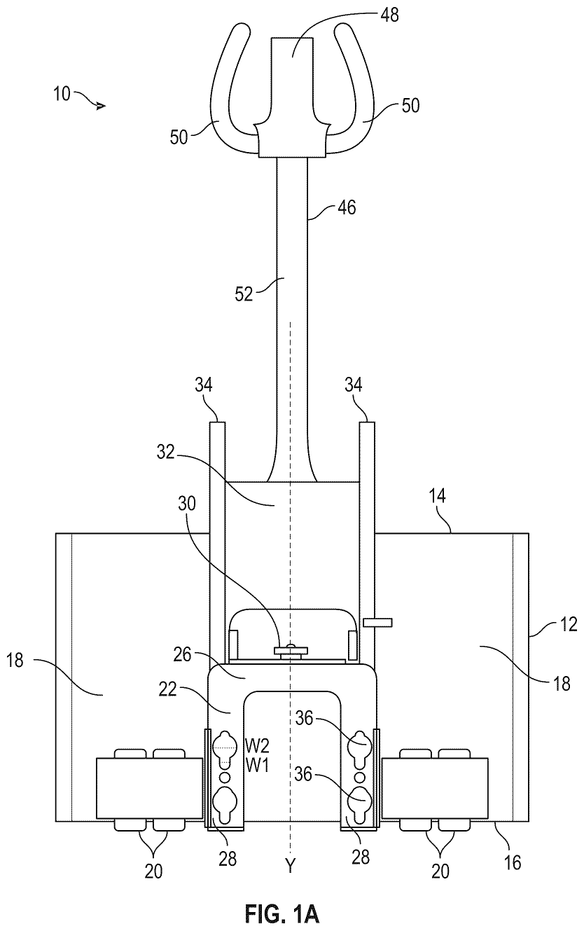

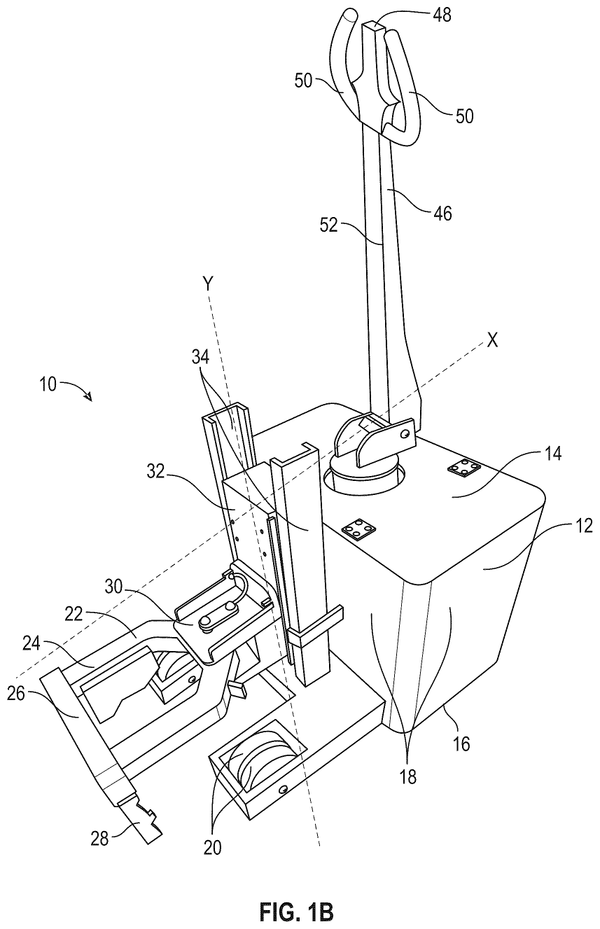

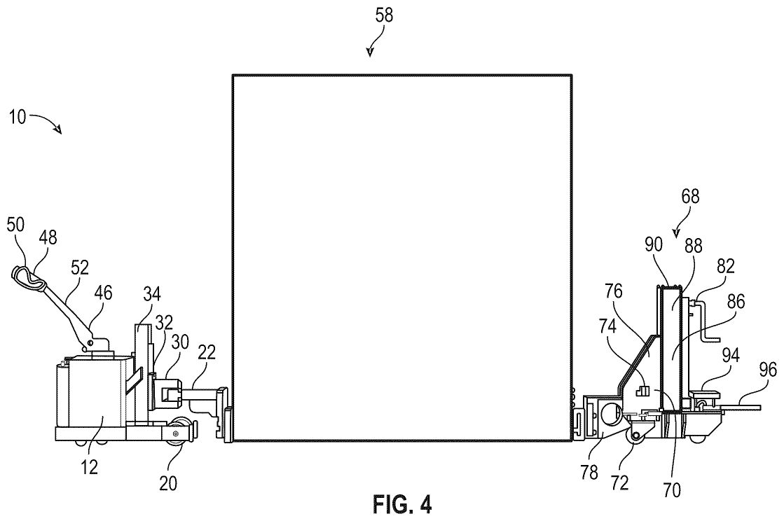

FIGS. 1A and 1B illustrate an example lifting tool. The lifting tool 10 is configured to lift and move a target lift object 58. The lifting tool 10 may be used in conjunction with a caboose tool 68 to lift and move the target lift object 58, for example, as described in detail in reference to FIGS. 4-6.

As shown in FIG. 1A, the lifting tool 10 may include a main body 12 with at least one wheel 20, a bracket 22, and a handle 46 connected to the main body 12. The main body 12 may be substantially rectangular with top and bottom surfaces 14, 16 parallel to each other, and four side surfaces 18 connected to each edge of the top and bottom surfaces 14, 16.

The bracket 22 may include a curved portion 24, a flat portion 26 connecting ends of the curved portion 24, and two extensions 28 connected and perpendicular to the flat portion 26. The curved portion 24 may be U-shaped. The curved and flat portions 24, 26 may be parallel to the top and bottom surfaces 14, 16 of the main body 12, and the two extensions 28 may be perpendicular to the top and bottom surfaces 14, 16 of the main body 12.

The extensions 28 may include holes 36 configured to receive shafts 60 connected to a target lift object 58, as detailed, for example, with reference to FIGS. 4-6. The holes 36 may each include a first width W₁ shorter than and parallel to a second width W₂, and a distance from the first width W₁ and the wheels 20 is shorter than a distance from the second width W₂ and the wheels 20. In other words, the hole 36 may have the second width W₂ as its largest width and taper or transition to the first width W₁ as its smallest width, and the first width may be below the second width W2. The shafts 60 can initially enter the portion of the hole 36 with the second width W₂ and then be secured in the position with the first width W₁ once in a lifted position, as detailed, for example, with reference to FIGS. 4-6. The holes 36 may have a shape including a main circle with two smaller circles towards the top and bottom surfaces of the lifting tool 10 and intersecting the main circle. In this example, the first width W₁ is within the smaller circle below and intersecting with the main circle, and the second width W₂ is within the main circle. However, the hole 36 may have any shape configured to receive and secure a shaft 60 on the target lifting tool 10. For example, the holes 36 may alternatively be a keyhole shape or an ovoid shape.

As shown in FIG. 1B, the bracket 22 may be pivotally connected to a lifting mechanism on one of the side surfaces 18a of the main body 12. The pivotal connection may allow the bracket 22 to rotate about a vertical axis Y to facilitate movement around tight corners, as described, for example, in reference to FIGS. 4-6. The pivotable connection may be through any securement means, such as a vertical pin that is sized slightly smaller than a pin hole in the bracket 22. The pin hole is configured to receive the securement means may be located at an apex of the curved portion 24. In other examples, the bracket 22 may be secured through a clamp or “snap” connection.

In addition to pivoting about the vertical axis Y, the bracket 22 may also be translatable along the vertical axis Y. The lifting mechanism may include a lifting portion 30 configured to receive the curved portion 24 of the bracket 22. The lifting portion 30 may be substantially rectangular and slightly larger than the height of the curved portion 24 of the bracket 22, e.g., enough space to allow the curved portion to fit within the space defined by either side of the lifting portion 30. The lifting mechanism might also include a lifting extension 32 perpendicular to the top and bottom sides 14, 16 of the lifting tool 10 and between two vertical extensions 34 with vertical edges curved towards each other. The vertical extensions 34 may be perpendicular to the top and bottom sides 14, 16 of the lifting tool 10. The vertical extensions 34 may be connected to a portion of the bottom surface 16 of the lifting tool 10. The connection may be monolithic. The lifting portion 30 may be configured to translate along the lifting extension 32 and between the two vertical extensions 34, as described in detail, for example, with reference to FIGS. 4-6. The translational movement may be through any means, such as by pulleys, chains, gears, or a combination thereof.

The wheels 20 may be configured to move the target lift object 58 once engaged with the target lift object 58. The wheels 20 may be connected to the bottom surface of the main body 12. There may be a total of eight wheels. The wheels 20 may be grouped in sets of two. There may be two sets of wheels 20 directly underneath the main body 12 and positioned parallel to the sides of the main body 12 perpendicular to the side connected to the bracket 22. There may be two additional sets of wheels 20, each set within a cavity in two extensions 28 of the main body 12 that are perpendicular to the side connected to the bracket 22. The cavity may be designed to restrict the movement of the wheels 20 to two directions. The wheels 20 may be connected to the main body 12 through a pin secured to the main body 12 that is sized slightly smaller than a hole in each wheel 20. In some examples, the lifting tool 10 may have any number of wheels and can be grouped in sets of any number of wheels. Additionally, the lifting tool 10 may include any type of design that restricts the movement of the wheels to two directions. Alternatively, the wheels may rotate and move in any direction. The lifting tool 10 may additionally include a mechanism, such as a lock pin, to stop the wheels from moving to be used, for example, in case of emergency that requires stopping movement of the system. In some examples, at least one of the wheels 20 is a motorized driving wheel configured to move the caboose tool 68.

The handle 46 may be configured to enable a user to manually move the lifting tool 10. The handle 46 may include a main portion 48 with two arms 50 in a semicircle shape, with the ends of each semicircle facing each other, connected to one end of a base 52. However, the handle 46 may be any shape configured for gripping. The base 52 of the handle 46 may be connected to the top side 14 of the main body 12. The connection may be pivotable along a horizontal axis X so that the height of the arms of the handle 46 can be adjusted from the ground for movement of the lifting tool 10. The pivotable connection may be through any securement means, such as a vertical pin that is sized slightly smaller than a hole in the handle 46. The hole configured to receive the securement means may be located at the base 52 of the handle 46.

The lifting tool 10 may be powered by mechanical movement from a user, by a battery, or by a motor. Preferably, the lifting tool 10 is powered by batteries and a motor.

The lifting tool 10 may further include hand controls and operation controls. The hand controls may include buttons or another type of user input for changing the speed, a horn, and a safety reverse. The operation controls may include an on/off key switch, a battery/hour meter with simple diagnostics, and a charging port. In some examples, the lifting tool 10 can be operated by a robot configured to interact with the lifting tool 10, e.g., through the hand controls and operation controls or through another interface, such as a data transmission interface for sending and receiving data to and from the lifting tool 10. The robot can be configured to cause the lifting tool 10 and/or caboose tool 68 to lift and move the target lift objects, e.g., through a sequence of instructions or control signals, or by physical interfacing with the hand controls and operation controls.

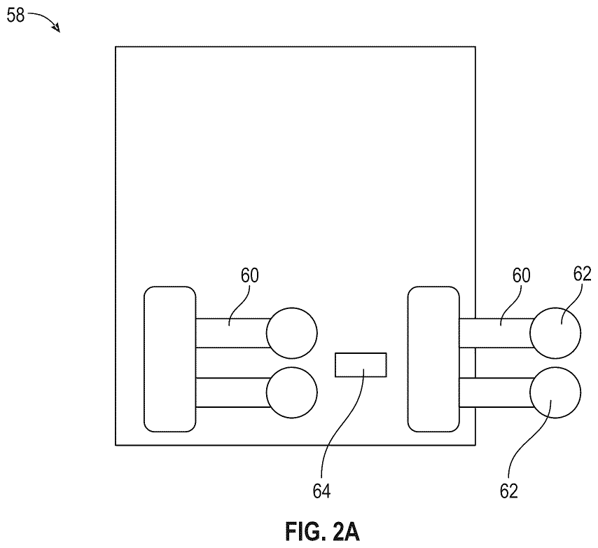

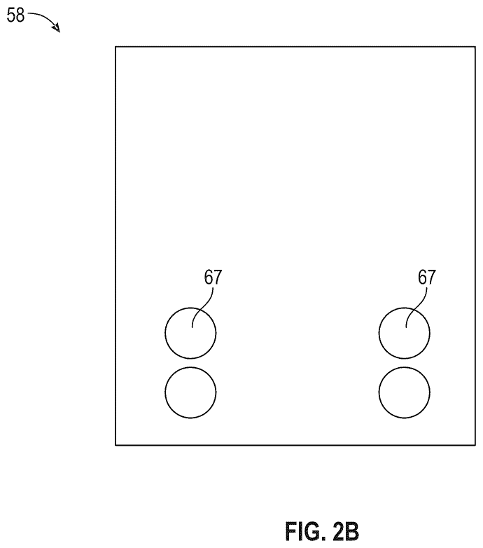

FIGS. 2A and 2B illustrate an example target lift object. The target lift object 58 is any object configured to engage with the bracket system of the lifting tool 10. For example, the target lift object 58 may be a robot for automated server handling, including a storage unit for storing server trays, and a gripper or other apparatus for removing and replacing server trays at a server rack. Robots configured for automated server handling can include a number of sensors, as well as electrical components running along the bottom surface of the robots. As such, robots of this type are not suited for lifting from the bottom surface, such as with a forklift or platform lifting the robots from the bottom. Lifting robots of this type from the bottom can result in damage to the robot, including to any sensors or components underneath the robot, along its bottom surface. Further, because the bottom surface of robots of this type is likely not flat and unimpeded, lifting from the bottom surface can be unstable and cause the robot to potentially tip and fall when lifted this way.

As shown in FIG. 1A, the target lift object 58 may include a series of shafts configured to engage with the bracket 22 of the lifting tool 10. The shafts 60 may be positioned on and perpendicular to one of the side surfaces of the target lift object 58. There may be the same number of shafts 60 on the target lift object 58 as holes 36 in the bracket 22 of the lifting tool 10. For example, if the bracket 22 on the lifting tool 10 has four total holes 36, the target lifting tool 10 may have four total shafts 60. More specifically, if the bracket 22 has two sets of holes 36 parallel to each other, the target lifting tool 10 may include two sets of shafts 60 parallel to each other as well and having the same distance between the two sets of shafts 60 as between the sets of holes 36.

The shafts 60 may include a cap 62 configured to prevent the lifting tool 10 from disengaging the target lift object. For example, the cap 62 on each shaft may have a width larger than the width of the top portion of the hole, as described in detail in connection with FIGS. 4-6. Each cap 62 may be threadedly attached to each shaft so that the caps 62 can be rotated to tighten the engagement between the lifting tool 10 and the target lift object, as described for example, with reference to FIGS. 4-6. In other examples, the caps 62 can be fixedly attached to the ends of the shaft 60.

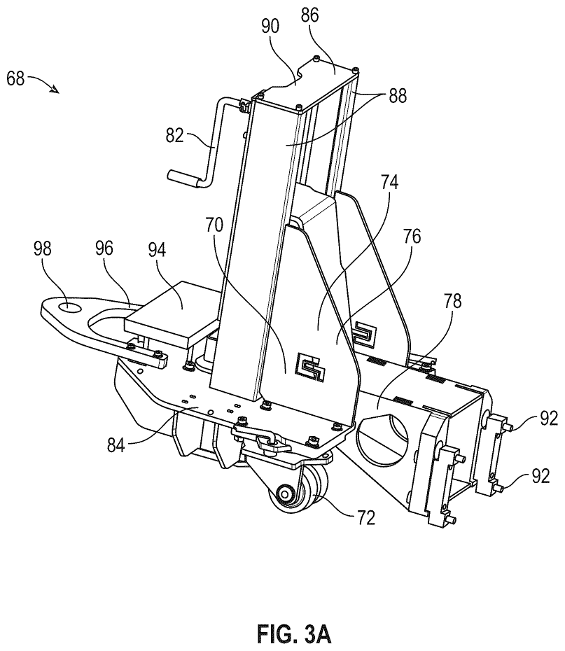

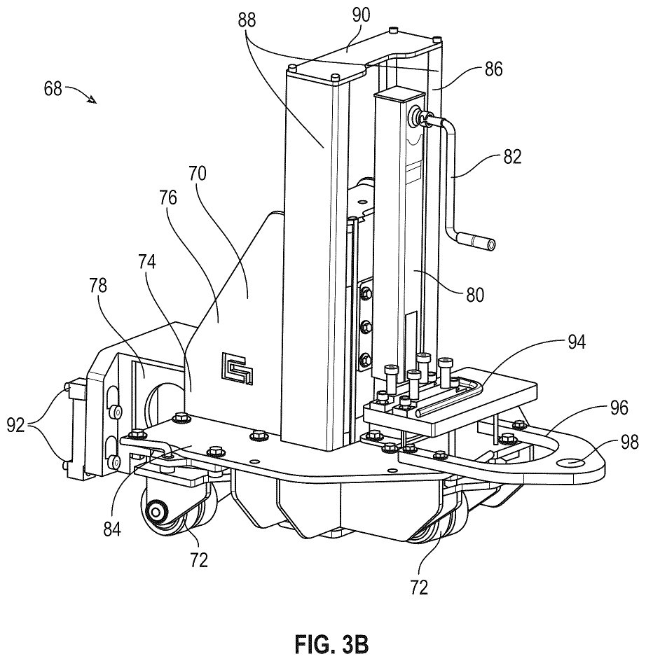

As shown in FIG. 2B, the target lift object 58 may include caboose holes 67 on a side opposite and parallel to the side including the series of shafts 60. The caboose holes 67 may be configured to receive protrusions from the caboose tool 68, for example, with reference to FIGS. 3A and 3B. Accordingly, the caboose holes 67 may be a diameter slightly larger than the diameter of the protrusions on the caboose tool 68.

The caboose holes 67 can be any shape configured to receive the protrusions on the caboose tool 68. For example, the caboose holes 67 may have a shape including a main circle with two smaller circles towards the top and bottom surfaces 14, 16 of the lifting tool 10 and intersecting the main circle. The holes may alternatively be a keyhole shape, an ovoid shape, or a circular shape.

The target lift object 58 may include at least one sensor 64 located between the series of shafts 60 and on the side of the target lift object 58 that engages with the lifting tool 10. The target lift object 58 may additionally include another sensor 64 on the side of the target lift object 58 that engages with the caboose tool 68. Specifically, the sensor 64 may be located so that the sensor 64 is not blocked when the target lift object and lifting or caboose tools 10, 68 are engaged, so that the sensor 64 can continue to receive information. The sensors 64 may, for example, be configured to detect the location of a target lift object 58 or other objects nearby, when the target lift object 58 is in operation, and/or used to guide or indicate when the lifting tool 10 or the caboose tool 68 are engaged with the target lift object 58. For example, the sensors 64 may emit light or make sounds based on the sensed presence of the lifting tool 10 or the caboose tool 68 relative to the target lift object 58.

FIGS. 3A and 3B illustrate an example caboose tool. The caboose tool 68 is configured to lift and move a target lift object in conjunction with the lifting tool 10.

As shown in FIG. 3A, the caboose tool 68 may include a caboose main body 70 with at least one wheel 72, a lifting mechanism 74, and a vertical shaft 80 with a manual hand crank 82 connected to the caboose main body 70. The caboose main body 70 may include a base portion and a frame 86 with two side surfaces parallel to each other and connected to a top surface 90.

As shown in FIG. 3B, the lifting mechanism 74 may include a substantially triangular prism 76 fixed with a substantially rectangular portion 78 that is perpendicular to the substantially triangular prism 76. The substantially rectangular portion 78 may be parallel with the base portion 84, and the base portion 84 may include a recess configured to fit the substantially rectangular portion 78. The end of the substantially rectangular portion 78 farthest from the substantially triangular prism 76 may include a series of lifting protrusions 92 configured to engage with the target lift object 58. There may be a total of four lifting protrusions 92, each lifting protrusion 92 placed near each corner of the substantially rectangular portion 78. The lifting protrusions 92 on the caboose tool 68 may be cylindrical and may be configured to be received within caboose holes 67 on the target lift object 58, for example, with reference to FIGS. 4-6.

The vertical shaft 80 may be connected to the substantially triangular prism 76 by any means of fixation. For example, the vertical shaft 80 may be connected to the substantially triangular prism 76 through three screws or other fasteners positioned either side of the vertical shaft 80.

The frame 86 may surround side and top surfaces 88, 90 of the substantially triangular prism 76. The internal side surfaces of frame 86 may include tracks configured to engage with the side surfaces of the substantially rectangular portion 78 and configured to move the substantially rectangular portion 78 in a vertical direction. The lifting mechanism 74 may be enabled through a mechanical hand crank 82 on the vertical shaft 80. Specifically, once the caboose is engaged with the target lift object 58, the mechanical hand crank 82 can be rotated to enable the lifting mechanism 74 to move in a vertical direction and therefore lift the target lift object 58. This translational movement may be through any means, such as by pulleys, chains, gears, or a combination thereof. The caboose tool 68 may include a platform 94 on and parallel to the caboose main body 70 directly below the hand crank 82 configured for a user to stand on the platform 94 to rotate the hand crank 82.

Alternatively, the lifting mechanism may be the bracket mechanism detailed in connection with FIGS. 1A and 1B, or the lifting mechanism can be configured to lift the target lift object from its bottom surface. However, the lifting mechanism may be any method configured to lift a target lift object 58, such as a belt-pull system, a press, or a motorized mechanism.

The caboose may further include a U-shaped bracket 96 with its ends connected to an end of the caboose main body 70 closest to the vertical shaft 80. The U-shaped bracket 96 may include a hole 98 at its apex configured to receive, for example, a device configured to tug the system. The U-shaped bracket 96 may be used, for example, in an assembly that does not include the lifting tool 10 as described herein.

The wheels 72 may be configured to move the target lift object 58 once the caboose tool 68 is engaged with the target lift object 58. The wheels 72 may be connected to the bottom surface 89 of the caboose main body 70. There may be a total of six wheels 72. The wheels 72 may be grouped in sets of two. There may be three sets of two wheels 72 directly underneath the caboose main body 70 and positioned parallel to the sides of the caboose main body 70 perpendicular to the side connected to the bracket. There may be a sheet of material on either side of each set of wheels 72 to restrict the movement of the wheels 72 to two directions. The wheels 72 may be connected to the caboose main body 70 through a pin secured to the caboose main body 70 that is sized slightly smaller than a hole in each wheel. However, the caboose tool 68 may have any number of wheels 72 and can be grouped in sets of any number of wheels 72. Additionally, the caboose tool 68 may include any type of design that restricts the movement of the wheels 72 to two directions. In some examples, the caboose tool 68 includes wheels 72 configured to rotate in any direction, e.g., on a pivot. In some examples, at least one of the wheels 72 is a motorized driving wheel configured to move the caboose tool 68.

The caboose tool 68 may be powered by mechanical movement from a user, by a battery, or by a motor. Preferably, the caboose tool 68 is mechanically powered by the mechanical hand crank 82.

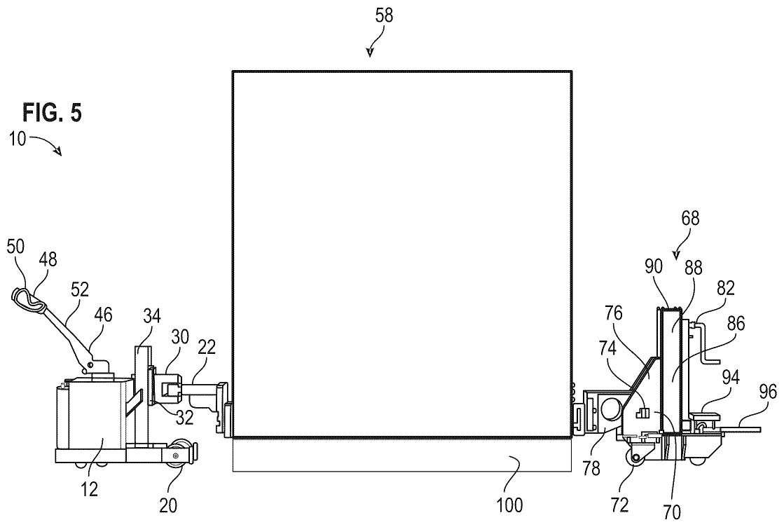

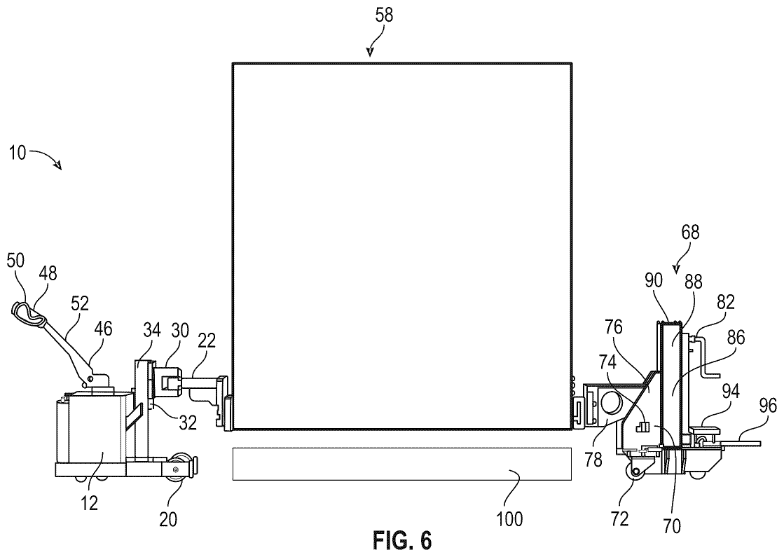

FIGS. 4-6 illustrate an example system in which a lifting tool 10 and a caboose tool 68 are engaged with the target lift object 58. FIG. 4 illustrates this system in an initial engagement position in which the target lift object 58 is on the ground, and FIG. 5 illustrates this system in an initial engagement position in which the target lift object 58 is on a raised surface. FIG. 6 illustrates this system in a lifted position.

As shown in FIG. 4, the lifting tool 10 may be directed, e.g., propelled, pushed, manually or using a motor, etc., towards the target lift object 58 until the holes of the lifting tool 10 are in line with the shafts 60 on the target lift object 58. As described in connection with FIG. 1A, the holes on the bracket of the lifting tool 10 may have a shape including a main circle with two smaller circles towards the top and bottom surfaces 14, 16 of the lifting tool 10 and intersecting the main circle. With this shape, the first width is within the smaller circle below and intersecting with the main circle, and the second width is within the main circle. The lifting tool 10 may specifically be directed so that the portion of the hole including the second width is in line with the shafts 60 of the target lift object 58. Directing of the lifting tool 10 may include moving the entire tool towards the target lift object 58 or may include translating the bracket along the vertical axis Y. Once the shafts 60 are received within the portion of the hole including the second width, the lifting tool 10 and target lift object 58 are in an initial engagement position. The caps 62 on the shafts 60 may be rotated so as to move the caps 62 closer to the target lift object 58 and therefore further secure the initial engagement position.

The initial engagement position may additionally include engagement of the caboose tool 68 with the target lift object 58. The caboose tool 68 may engage with a side of the target lift object 58 opposing and parallel to the side in which the lifting tool 10 engages with the target lift object 58. The caboose tool 68 may be directed so that the portion of the lifting protrusions 92 on the caboose tool 68 are in line with the caboose holes 67 on the target lift object 58. Once the projections are received within the caboose holes 67, the caboose tool 68 and target lift object 58 are in an initial engagement position. However, as stated in connection with FIGS. 3A and 3B, the caboose tool 68 can have any means of engaging the target lift object 58. The caboose tool 68 may be engaged with the target lift object 58 before, during, or after the target lift object 58 is engaged with the lifting tool 10.

The initial engagement position may occur when the target lift object 58 is on the same surface as the lifting and caboose tools 10, 68. In other words, the initial engagement position may occur when the lowest point of the target lift object 58 is parallel with the lowest points of the lifting and caboose tools 10, 68. Alternatively, the initial engagement position may occur when the target lift object 58 is on a higher surface than the lifting and caboose tools 10, 68. In other words, the initial engagement position may occur when the lowest point of the target lift object 58 is higher than the lowest points of the lifting and caboose tools 10, 68. For example, as shown in FIG. 5, the target lift object 58 may be on a pallet 99.

As shown in FIG. 6, a user may initiate translational movement of the lifting mechanism on a vertical axis Y to lift the engaged target lift object 58. Accordingly, the holes of the bracket may move so that the shaft is located within the portion of the hole including the first width. Since the first width may be smaller than the second width, the shafts 60 may be secured since the protrusion on the shafts 60 may be larger than the first width and therefore prevent disengagement of the shafts 60. Once the target lift object 58 has been lifted, the lifting tool 10 and target lift object 58 are in a lifted position.

The initial engagement position may additionally include a user initiating translational movement of the lifting mechanism of the caboose tool to lift the engaged target lift object 58. The lifting mechanism can be initiated by rotation of the mechanical hand crank 82. However, as stated in connection with FIGS. 3A and 3B, the caboose tool can have any means of engaging the target lift object 58. For example, the caboose tool 68 may be powered by mechanical movement from the mechanical hand crank 82. The caboose tool may lift the target lift object 58 before, during, or after the lifting tool 10 lifts the target lift object 58. However, the caboose and lifting tools 10, 68 preferably lift the target lift object 58 simultaneously for improved stability and to prevent damage to the target lift object 58.

The caboose and lifting tools 10, 68 may lift the target lift object 58 to the same height to prevent damage to the target lift object 58. The lifting mechanisms may be configured so that the target lift object is not lifted past a preset height. For example, the preset height may be 2 5/16 inches. Additionally, the target lift object 58 may be lifted in increments. The increments may range from ⅛ to a ¼ of an inch.

The target lift object 58 can be moved in the lifted position. The target lift object 58 may be moved by pulling or pushing the handle 46 on the lifting tool 10. The target lift object 58 can also be moved around a space using tracks. Alternatively, the target lift object 58 can also be moved autonomously, for example, if the lifting tool 10 is a mobile robot. In some examples, the caboose tool can be configured to propel or push the target lift object 58. In these examples, the handle 46 on the lifting tool 10 can be used to steer the lifting tool 10.

The bracket 22 on the lifting tool 10 can rotate around a vertical axis Y, allowing the target lift object 58 to be moved around tight corners. This system is advantageous, for example, to move a target lift object 58 within a data center. To maximize space within data centers, server racks are typically placed as close to each other as possible. As a result, data centers have narrow aisles and tight corners. Since the contents of a data center are costly and the lifting tool and caboose tool described herein can be used to move a target lift object 58 with a stable lifting mechanism in a stable fashion, maneuverable around tight corners.

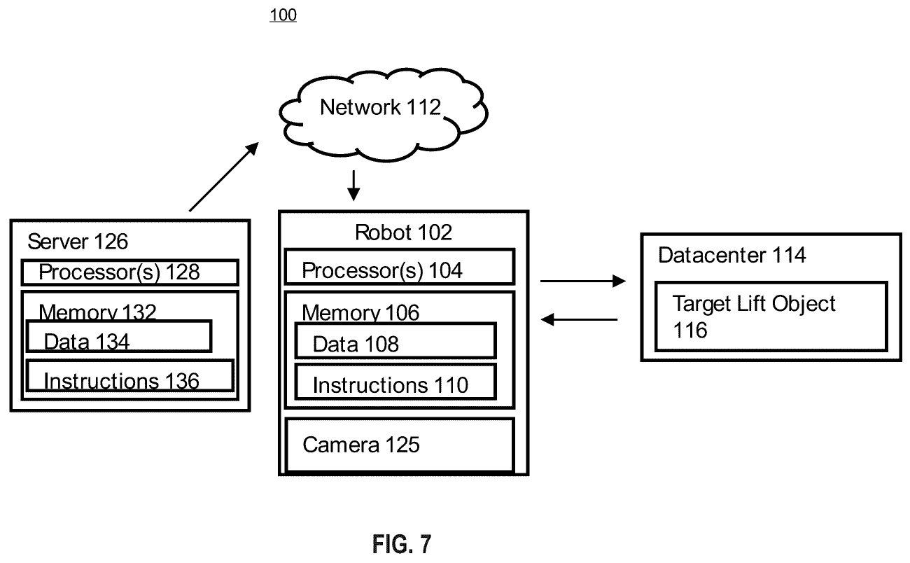

FIG. 7 is a block diagram of an example system 100 for lifting and moving a target lift object. FIG. 7 illustrates an example system 100 in which the features described above may be implemented. In this example, the system 100 may include a lifting tool 102, a target lift object 116, a network 112, and a datacenter 114.

The lifting tool 102 and caboose tool 68 may lift and move the target lift object, for example as described in detail in connection with FIGS. 4-6. However, instead of manually directing the lifting tool 102, the lifting tool 10 may be a robot 102. The robot 102 may be mobile and may include one or more processors 104 and a memory 106. The memory 106 of the robot 102 includes data 108 and instructions 110. The data 108 may include a machine learning program or a visual system that can create a 3D visualization of a target lift object 116. In some examples, the robot 102 is configured to use a camera 125 or other sensors (not shown) to identify the position of the shafts 60 and holes on the target lift object 116, for guiding the lifting tool 10 and the caboose tool to engage with the target lift object 116. The instructions 110 may include an external database of coordinates of the locations of the shafts 60 on the target lift object 116. The instructions 110 allow the robot 102 to navigate the datacenter 114 to complete lifting and moving of the target lift object 116. The data 108 allows the robot 102 to identify which target lift object 116 in the data center needs to be moved.

In some examples, the lifting tool 10 may be coupled to the robot 102. The robot 102 can be configured to pull or push the lifting tool 10, for example as a manual operator would interact with the handle 46 or other controls of the tool. In other examples, the robot 102 can connect through a different interface, for example a separate connection or tether, enabling the robot 102 to move the lifting tool 10 in the lifted position.

Memory 106 of the robot 102 can store information accessible by the one or more processors 104, including instructions 110 that can be executed by the one or more processors 104. Memory 106 can also include data 108 that can be retrieved, manipulated, or stored by the processor. The memory 106 can be of any non-transitory type capable of storing information accessible by the processor, such as a hard-drive, memory card, read-only memory (“ROM”), random access memory (“RAM”), optical disks, as well as other write-capable and read-only memories. Memory 106 may store information that is accessible by the processors 104, including instructions 110 that may be executed by processors 104, and data 108.

The instructions 110 can be any set of instructions to be executed directly, such as machine code, or indirectly, such as scripts, by the one or more processors. In that regard, the terms “instructions,” “application,” “steps,” and “programs” can be used interchangeably herein. The instructions can be stored in object code format for direct processing by a processor, or in any other computing device language including scripts or collections of independent source code modules that are interpreted on demand or compiled in advance.

Data 108 may be retrieved, stored, or modified by the one or more processors 104 in accordance with the instructions 110. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII, or Unicode. Moreover, the data can include any information sufficient to identify the relevant information, such as numbers, descriptive text, proprietary codes, pointers, references to data stored in other memories such as at other network locations, or information that is used by a function to calculate the relevant data.

The one or more processors 104 may include any conventional processor, such as a CPU or microprocessor. Alternatively, the processor can be a dedicated component such as an ASIC or other hardware-based processor. Although not necessary, the server 126 may include computing devices that include specialized hardware components to perform specific computing functions faster or more efficiently.

Although FIG. 6 functionally illustrates the processor, memory, and other elements of the robot 102 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the robot 102. Accordingly, references to a processor or server will be understood to include references to a collection of processors, servers, or memories that may or may not operate in parallel.

System 100 further includes the server 126 utilized to provide data 134 and instructions 136 to the robot 102 through the network 112. The server 126 may include a processor 128 and a memory 132. The memory 132 may include data 134 and instructions 136. The data 134 may include a database of relative coordinates of each shaft on each target lift object 116.

Processor 128, memory 132, data 134, and instructions 136 of the server 126 can be structurally and functionally similar to above disclosed processors 104, memory 106, data 108, and instructions 110 of the robot 102.

The robot 102 may be intended for use by a respective user, and have all of the components normally used in connection with a computing device including one or more processors (e.g., a central processing unit (CPU)), memory (e.g., RAM and internal hard drives) storing data and instructions, an output, such as a display (e.g., a monitor having a screen, a touch-screen, a projector, a television, or other device such as a smart watch display that is operable to display information), and user input devices (e.g., a mouse, keyboard, touchscreen or microphone). The robot 102 may also include a camera 125 for recording video streams, speakers, a network interface device, and all the components used for connecting these elements to one another. The robot 102 may be capable of wirelessly exchanging or obtaining data over the network 112.

Although the robot 102 may include a full-sized computing device, it may alternatively include mobile computing devices capable of wirelessly exchanging data with a server over a network such as the Internet. By way of example only, robot 102 may include a mobile phone or a device such as a wireless-enabled PDA, a tablet PC, a netbook, a smart watch, a head-mounted computing system, or any other device that is capable of obtaining information via the Internet. As an example, robot 102 may receive user input from a user input device, such as a keyboard, a keypad, microphone, using visual signals with a camera, or a touch screen.

The robot 102 and the server 126 can be at various nodes of a network 112 and capable of directly and indirectly communicating with other nodes of network 112. Although one robot 102 and one server 126 is depicted in FIG. 6, it should be appreciated that a system can include one or more devices or servers, with each device or server being at a different node of network 112. The network 112 and intervening nodes described herein can be interconnected using various protocols and systems, such that the network can be part of the Internet, World Wide Web, specific intranets, wide area networks, or local networks. The network 112 can utilize standard communications protocols, such as WiFi, Bluetooth, 4G, 5G, or any other manner of transmission or protocol.

In one example, system 100 may include one or more servers, e.g., server 126 having one or more computing devices, e.g., a server farm, which is configured to exchange information with different devices of a network for the purpose of receiving, processing, and transmitting the data to and from other computing devices. For instance, the server 126 may be a web server that is capable of communicating with the one or more robots, such as the robot 102, using the network 112. The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

In some examples, the term “configured” is used herein in connection with systems and computer program components. For a system of one or more computers to be configured to perform particular operations or actions means that the system has installed on IT software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

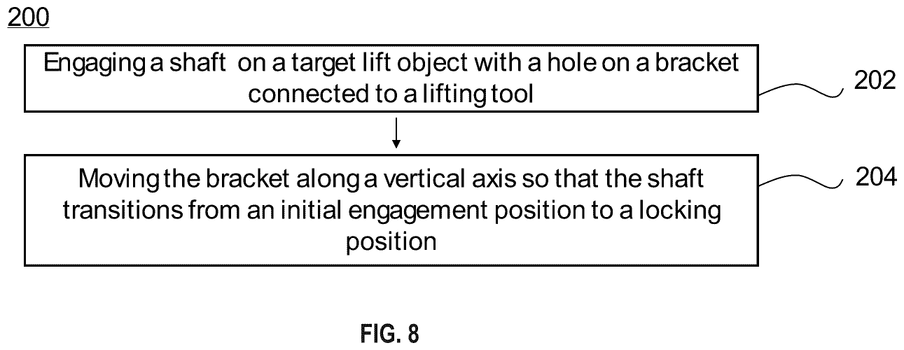

FIG. 8 is a flow diagram for an example process 200 of lifting and moving a target lift object 58. As described herein with reference to FIGS. 1-6, a lifting tool 10 and caboose tool 68 can be used to lift and move a target lift object 58. The following operations do not have to be performed in the precise order described below. Rather, various operations can be handled in a different order or simultaneously, and operations may be added or omitted.

In block 202, the lifting tool 10 engages a shaft 60 on a target lift object 85 with a hole on a bracket 22 connected to the lifting tool 10. In block 204, the bracket 22 on the lifting tool 10 moves along a vertical axis Y so that the shaft 60 transitions from an initial engagement position to a locking position. The lifting tool 10 in blocks 202 and 204 may be a mobile robot. In some examples, a mobile robot is configured to perform the process 200, for example by physically interacting with the lifting tool as described above, and/or by sending control signals or instructions to the lifting tool configured to perform the operations of the process 200.

Although the implementations disclosed herein have been described with reference to particular features, it is to be understood that these features are merely illustrative of the principles and applications of the present implementations. It is therefore to be understood that numerous modifications, including changes in the sizes of the various features described herein, may be made to the illustrative implementations and that other arrangements may be devised without departing from the spirit and scope of the present implementations. In this regard, the present implementations encompass numerous additional features in addition to those specific features set forth in the paragraphs above.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many examples. Further, the same reference numbers in different drawings can identify the same or similar elements.

1. A lifting tool comprising:
a main body configured to be connected to at least one wheel and a bracket, the bracket translatable along a vertical axis on the main body and comprising two sets of holes parallel to each other, each hole having a first width and a second width longer than and parallel to the first width,
wherein a distance from the first width and the at least one wheel is shorter than a distance from the second width and the at least one wheel.

2. The lifting tool of claim 1, wherein the bracket is rotatable about the vertical axis.

3. The lifting tool of claim 1, wherein the at least one hole is a main circle with a smaller circle intersecting the main circle, wherein the first width is within the smaller circle, and wherein the second width is within the main circle.

4. The lifting tool of claim 1, wherein the at least one hole is keyhole shaped.

5. The lifting tool of claim 1, wherein the at least one hole is ovoid.

6. The lifting tool of claim 1, wherein the two sets of holes each include two holes in a vertical line.

7. The lifting tool of claim 1, wherein the lifting tool is a mobile robot configured to push a target lift object.

8. The lifting tool of claim 1, further comprising a motor.

9. The lifting tool of claim 1, further comprising a lock pin adjacent to the at least one wheel and configured to prevent the at least one wheel from rotation.

10. A system for lifting and moving a target lift object comprising:
a lifting tool comprising:
a main body connected to at least one wheel and a bracket, the bracket comprising two sets of holes parallel to each other, each hole having a first width and a second width longer than and parallel to the first width,
wherein a distance from the first width and the at least one wheel is shorter than a distance from the second width and the at least one wheel, and
a target lift object comprising a first side with at least one shaft with a cap on an end of the shaft farthest from the target lift object, wherein the shaft is configured to be received within the holes, and wherein the cap is configured to prevent disengagement of the shaft once the shaft is engaged with a portion of the holes within the first width.

11. The system of claim 10, wherein the target lift object comprises at least one sensor configured to detect input in a space between the two sets of holes.

12. The system of claim 10, further comprising a caboose tool configured to engage with a second side of the target lift object opposing and parallel to the first side of the target lift object.

13. The system of claim 12, wherein the caboose tool comprises a lifting protrusion configured to be received within a lifting hole on the second side of the target lift object.

14. The system of claim 13, wherein the caboose tool comprises a hand crank on a side of the caboose tool opposite of the lifting protrusion, the hand crank configured to engage a lifting mechanism to lift the target lift object.

15. The system of claim 10, wherein a lowest portion of the lifting tool is in line with a lowest portion of the target lift object.

16. The system of claim 10, wherein a lowest portion of the lifting tool is below a lowest portion of the target lift object.

17. The system of claim 16, wherein the lowest portion of the lifting tool is three inches below the lowest portion of the target lift object.

18. The system of claim 11, further comprising treads configured to receive the at least one wheel on the lifting tool and configured to move the lifting tool in at least one direction.

19. A method of lifting and moving a target lift object comprising:
engaging, by a mobile robot, a shaft on a target lift object with a hole on a bracket connected to a lifting tool, wherein the hole has a first width and a second width longer than and parallel to the first width; and
moving, by the mobile robot, the bracket along a vertical axis so that the shaft transitions from an initial engagement position within the second width of the hole to a locking position within the first width of the hole, wherein a cap on the shaft prevents disengagement of the shaft in the locking position.

20. The method of claim 19, wherein the lifting tool is the mobile robot, and wherein the step of engaging the shaft with a hole includes guiding the lifting tool using a control device.
